(19) United States
(12) Patent Application Publication
(10) Pub. No.: US 2003/0131120 A1
(43) Pub. Date: Jul. 10, 2003

(54) Automation and dynamic matching of business to business processes

(75) Inventors: Philip Y. Chang, Austin, TX (US); Virgil A. Albaugh, Austin, TX (US); Hari H. Madduri, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY (US)

(21) Appl. No.: 10/042,480

(22) Filed: Jan. 9, 2002

(51) Int. Cl. G06F 15/16

(52) U.S. Cl. 709/232

(57) ABSTRACT

The invention provides a method of automating the matching of business to business processes. One or more companies may submit their transmission capabilities. The companies' transmission capabilities may be stored in a managed hub. One company may send a request to do business with another company. The possible translation paths between the two companies may be computed.

### FIELD OF THE INVENTION

The invention relates, generally, to a method of automating the matching of business to business transmissions.

### BACKGROUND OF THE INVENTION

Nowadays, many companies are doing business via the Internet and via computer transactions. In business to business computer transactions, companies typically must pre-arrange how data is to be transmitted and what sequence of messages are to be transmitted. The negotiations of this ‘public process’ between companies are time consuming and costly. Most of the existing implementations reflect this cost and only large companies can afford to negotiate and implement the processes.

There is a need for a less expensive solution that will enable an automated ‘matching’ of processes so that companies can get involved in business to business processes automatically. Each company could specify its capabilities to an intermediary that would perform dynamic matching of the capabilities and allow a dynamically built business to business process to proceed quickly and economically.

### SUMMARY OF THE INVENTION

One aspect of the present invention is a method of automating the matching of business to business processes. One or more companies will submit their support capabilities. The companies' transmission capabilities may be stored in a managed hub. The translation capabilities of the managed hub may also be stored. One company will send a request to do business with the other company. The possible translation paths between the two companies may be mapped. One company may send a request to do business with the other company. The possible translation paths between the two companies may be computed based on the transmission and translation capabilities of the two companies and the translation capabilities of the managed hub.

Another aspect of the present invention is a computer usable medium automating the matching of business to business processes comprising computer readable code for storing one or more companies' support capabilities, computer readable code for storing the translation capabilities of the managed hub, computer readable code for receiving a request from one company to do business with another company, and computer readable code for computing the translation paths between the two companies support capabilities.

Another aspect of the present invention is a system for automating the matching of business to business processes comprising means for storing one or more companies' support capabilities; means for receiving a request from one company to do business with another company; and means for computing the translation paths between the two companies support capabilities.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram illustrating one embodiment of a system for automating the matching of a business to business transmission in accordance with the present invention;

FIG. 2 is a flowchart representation of one embodiment of a method for automating the matching of a business to business transmission for the system of FIG. 1, in accordance with the present invention;

FIG. 3 is a flowchart representation of a preferred embodiment of a method for translating support capabilities within a managed hub for the system of FIG. 1, in accordance with the present invention.

FIG.4 is a flowchart representation of a preferred embodiment of a method for computing the translation path given the transmission capabilities of two businesses and the translation capabilities of the managed hub for the system of FIG. 1, in accordance with the present invention.

### DETAILED DESCRIPTION OF THE PRESENTLY PREFERRED EMBODIMENTS

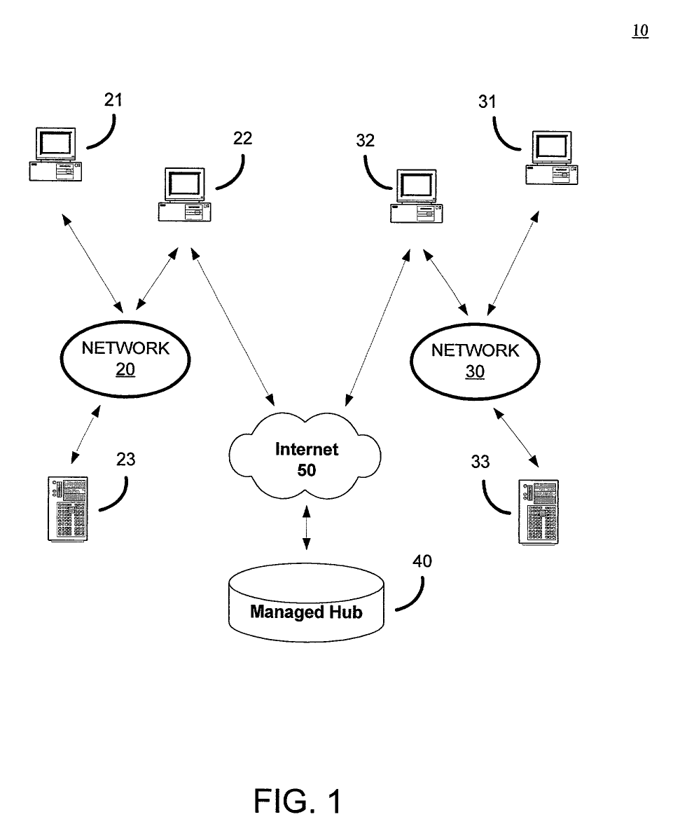

In FIG. 1, a system 10 is illustrated in accordance with one embodiment of the present invention. As shown in FIG. 1, the system 10 may contain two network-based systems, 20 and 30. In this example, each network-based system may contain computer, 21, 22, 31, 32, and servers, 23 and 33. The networks, 20 and 30, may provide communication links between various devices and computers connected together within this environment. Networks 20 and 30 may include permanent connections, such as wire or fiber optic cables, or temporary connections made through telephone or wireless communications. In one embodiment, a computer 21, 22 from within network 20 may register its transmission capabilities with the management hub 40 via the Internet 50. Transmission capabilities may also be registered, in other embodiments, through a cellular network, satellite networks, a personal communication system, a TV network (e.g., a cable TV system), local, regional, national or global paging networks, and a wireless data network (e.g., satellite data or local wireless data networks. A computer 31, 32 from another network, 30, may also register its transmission capabilities with the management hub 40 via the Internet 50. Transmission capabilities may also be registered, in other embodiments, through a cellular network, satellite networks, a personal communication system, a TV network (e.g., a cable TV system), local, regional, national or global paging networks, and a wireless data network (e.g., satellite data or local wireless data networks. The managed hub, 40, may compute the translation paths between the support capabilities of the two companies, represented by networks 20 and 30. A business having network 20, may request to do business with another company, represented by network 30. The translation paths may be delivered to that business, represented by network 20, so they may continue their business transaction.

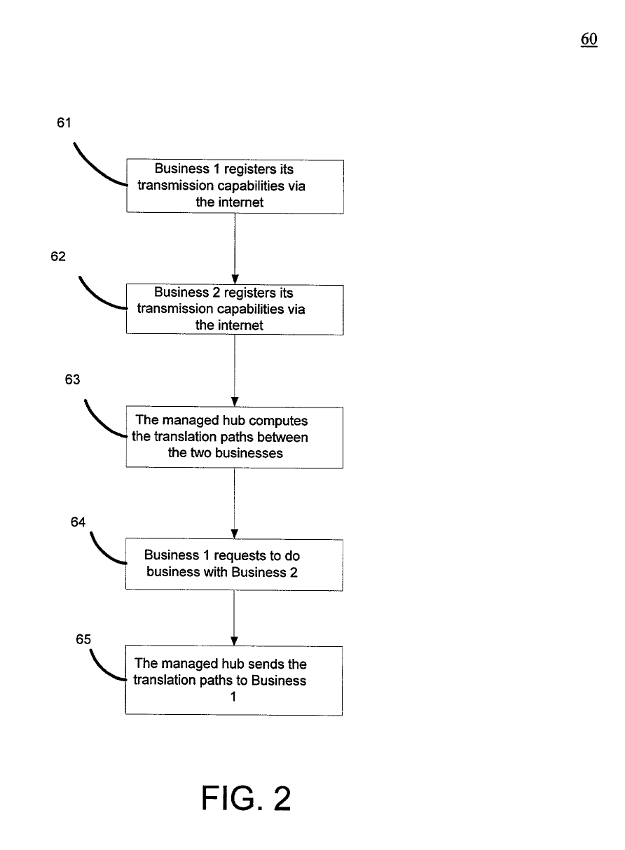

Referring now to FIG. 1 and FIG. 2, one embodiment of a method for automating the matching of a business to business transmission is shown. Business 1, as depicted by network 20 in FIG. 1, may register its transmission capabilities with the managed hub, 40, shown in FIG. 1 via the Internet, (Block 61). For example, Business 1 may be able to support process formats X, Y, and Z. Business 2, as depicted by network 30 in FIG. 1, may register its transmission capabilities with the managed hub, 40, shown in FIG. 1 via the Internet (Block 62). For example, Business 2 may be able to support process formats M, N, and P. The managed hub may support the following capabilities: Y may be transformed to P, Z may be transformed to O, and O may be transformed to N. Next, the managed hub, 40, shown in FIG. 1 may map the translation paths between the two businesses (Block 63). The managed hub may dynamically compute the paths Y to P and Z to O to N as two alternative processes A may use. Business 1 may request to do business with Business 2 (Block 64). At that point, the managed hub, 40, shown in FIG. 1 may send the translation paths, consisting of the transmission capabilities of the companies and translation capabilities of the managed hub, between the two businesses to Business 1 (Block 65) for selection of one translation path as the preferred way to do business with Business 2. Alternatively, this process may happen at run time when Business 1 sends a message in format Y, the dynamic matching process may pick Y to P as the translation path and send message in format P to Business 2.

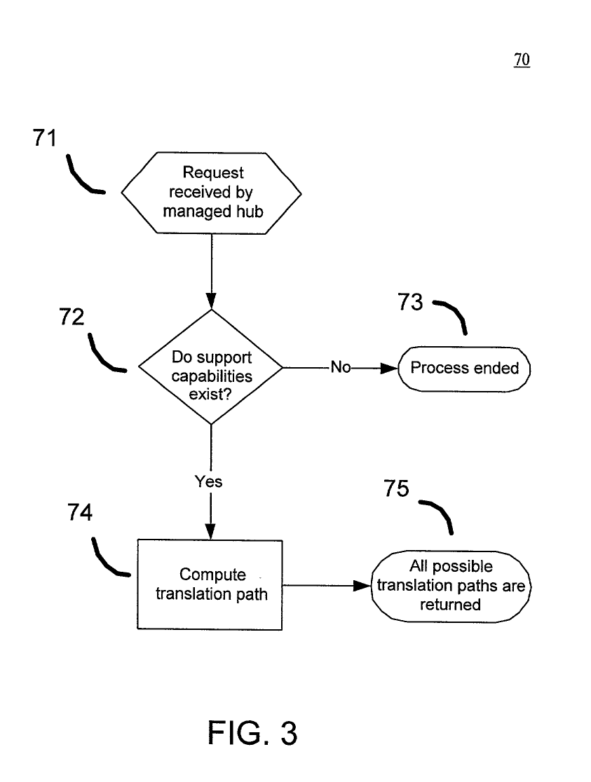

Referring now to FIG. 1 and FIG. 3, one embodiment of a method for translating transmission capabilities within a managed hub, shown in FIG. 3 at 70. A request may be received by Business 1, depicted by network 20 in FIG. 1, to do business with Business 2, depicted by network 30 in FIG. 1 (Block 71). The managed hub, shown in FIG. 1 at 40, may be searched to see if transmission support capabilities exist for Business 1 and Business 2 (Block 72). If no such capabilities exist, the process may be ended (Block 73). If transmission capabilities exist for both businesses, the translation paths may be computed by the managed hub 40 (Block 74). All possible translation paths, consisting of the transmission capabilities of the companies and translation capabilities of the managed hub, may be returned to Business 1 by the managed hub (Block 75).

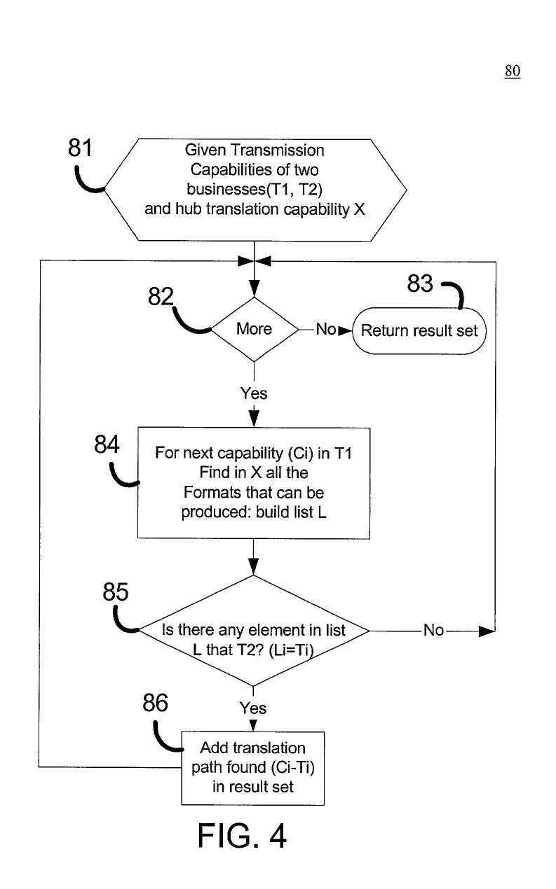

Referring now to FIG. 1 and FIG. 4, one embodiment of a method for computing the translation path given the transmission capabilities of two businesses and the translation capabilities of the managed hub, is shown in FIG. 4 at 80. The managed hub contains transmission capabilities of two businesses (T1, depicted by network 20 in FIG. 1, and T2, depicted by network 30 in FIG. 1) and managed hub translation capability X (Block 81). If there are no more transmission capabilities (Block 82) the result set will be returned (Block 83). If there is at least one additional transmission capability, for the next capability (Ci) in T1, all of the formats in X that can be produced will be stored in a list L (Block 84). The managed hub may then determine if there are any elements in list L that matches a transmission capability of T2 (Block 85). If a match does exist, the translation path (Ci-Ti), consisting of the transmission capabilities of the companies and translation capabilities of the managed hub, will be added to the result set (Block 86).

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim

1. A method of automating the matching of business to business processes comprising:
receiving transmission capability from a first company and a second company;
storing transmission capabilities;
receiving a request from one of the first and second companies to do business with the other company; and
determining at least one translation path between the first and second companies based on the transmission capabilities and translation capabilities.

2. The method of claim 1 wherein the transmission capabilities represent process formats supported by each company.

3. The method of claim 2 further comprising storing transmission capabilities in a managed hub.

4. The method of claim 1 wherein the translation capabilities represent mapping from one data format to another.

5. The method of claim 4 further comprising storing the translation capabilities in a managed hub.

6. The method of claim 1 wherein the request from one of the first and second companies is regarding any business to business computer transaction.

7. The method of claim 1 wherein the translation path represents a number of data transformation and process translation capabilities.

8. A computer usable medium containing computer readable code for automating the matching of business to business processes comprising:
computer readable code for receiving transmission capability from a first company and a second company;
computer readable code for storing transmission capabilities;
computer readable code for receiving a request from one of the first and
second companies to do business with the other company; and
computer readable code for determining a translation path between the first and second companies based on the transmission and translation capabilities.

9. The computer usable medium of claim 8 wherein transmission capabilities represent process formats supported by each company.

10. The computer usable medium of claim 9 further comprising storing transmission capabilities in a managed hub.

11. The computer usable medium of claim 8 wherein the translation capabilities represent mapping from one data format to another.

12. The computer usable medium of claim 11 further comprising storing the translation capabilities in the managed hub.

13. The computer usable medium of claim 8 wherein the request from one of the first and second companies is regarding any business to business computer transaction.

14. The computer usable medium of claim 8 wherein the translation path represents a number of data transformation and process translation capabilities.

15. A system for automating the matching of business to business processes comprising:
means for receiving transmission capability from a first company and a second company;
means for storing transmission capabilities;
means for receiving a request from one of the first and second companies to do business with the other company; and
means for determining a translation path between the first and second companies based on the transmission and translation capabilities.

16. The system of claim 15 further comprising means for storing the transmission capabilities in a managed hub.

17. The system of claim 15 further comprising means for storing the translation capabilities in a managed hub.
